(19) United States
(12) Patent Application Publication
(10) Pub. No.: US 2022/0388264 A1
(43) Pub. Date: Dec. 8, 2022

(54) SEGMENTED ROLLER, IN PARTICULAR FOR COMMINUTING OR COMPACTING BULK MATERIAL

(71) Applicant: TAKRAF GmbH, Leipzig (DE)

(72) Inventors: Andreas EICHLER, Leipzig (US); Marko SCHMIDT, Leipzig (DE); Marcus MEINEL, Leipzig (DE)

(73) Assignee: TAKRAF GmbH, Leipzig (DE)

(21) Appl. No.: 17/805,355

(22) Filed: Jun. 3, 2022

(30) Foreign Application Priority Data
Jun. 3, 2021 (DE) 10 2021 114 404.3

(51) Int. Cl. B30B 3/00

(52) U.S. Cl. CPC B30B 3/005

(57) ABSTRACT

The invention relates to a method for mounting segments on and dismounting segments from a roller shaft. These segments are braced on the roller shaft via at least one bracing element in a receptacle provided for this purpose and are thus frictionally and form-fittingly connected in their position.

This application claims priority to German Application No. 10 2021 114 404.3, filed on Jun. 3, 2021, the entire contents of which are hereby incorporated herein by reference.

The invention relates to a new design for rollers which consist of segments, in particular for comminuting or compacting bulk material.

Bulk material is comminuted and compacted in high-pressure roller mills (roller presses) in the gap between two counter-rotating smooth rollers. Said rollers consist of a roller shaft, a roller main body (roller core), and a roller shell. If the shaft, main body, and shell are formed in one piece, this is referred to as a solid roller. If the roller shell is separate, on the other hand, this is referred to as a compound roller.

Within the meaning of the present invention, the segmented roller is defined as being formed by a roller shaft and a roller shell. The segmented roller preferably has a one-piece roller shaft. The roller core can be a separate or integral component of the roller shaft or roller shell. The roller shell is made up of segments.

Solid rollers can be manufactured as composite castings to achieve the required wear resistance. However, they usually consist of a forged part of which the surface is protected by build-up welding or grid armour (hard metal pins with a material bed formed in between as autogenous wear protection). Nevertheless, due to the low material utilisation, solid rollers are usually only used in the cement industry, where high pressing pressures, but low wear rates (e.g. 0.1-1.0 g/t), are to be expected. The use of roller presses in the ore industry, where significantly higher wear rates of e.g. 3-10 g/t occur despite lower pressing pressures, only became possible with the use of compound rollers. Drum rollers, in which the roller shell is unsegmented (“drum”) and the forged part (with grid armour using hard metal pins, sintered wear plates, or build-up welding) or cast part (white cast iron or compound cast) is designed, are widely used in this field.

However, the shells of drum rollers cannot be dismounted radially, and therefore replacing worn roller surfaces requires the entire roller to be removed and thus leads to longer downtimes (loss of production) and high replacement and mounting costs.

The following documents, which concern segmented and radially dismountable roller shells, are known from the prior art.

DE°39°27°884° A1 discloses a segmented roller with complementary projections and recesses in the adjacent radially arranged segments and the entire body and surface thereof, which result in radial toothing. These are braced together and against the roller shaft by means of clamp elements via clamping screws and tie rods, which run axially through the roller shaft. In addition, there are those arranged axially in the roller shaft. The disadvantage here is that the roller must be removed or have recesses in the housing wall of the roller crusher which allow dismounting in the installed state. The manufacturing accuracies required to manufacture the segments and the roller shaft are considerable for the feather keys to correspond to the grooves of the roller shaft and segments.

DE°197°09°263° A1 represents a further development of this document and does not have any feather keys or feather key grooves, but instead reduces the projections and recesses from the roller surface to the roller shaft and supplements them with axial rows of teeth. Similarly to the previously mentioned disadvantages, a disadvantage here is that the accuracies for producing the receptacles for the tie rods, the protruding projections for the U-shaped clip elements of the tie rods, and the manufacture of the projections and recesses of the segments relative to one another are complex and therefore expensive.

The roller in DE 3 915 320 A1 is also designed without keys and key grooves and has sawtooth-shaped recesses on the roller main body. The segments of the roller shell are fastened to the roller main body by means of fastening flanges or are clamped to the roller main body by means axial clamping screws and clamping plate segments.

DE°43°44°206° A1 discloses clamping rings which are arranged axially on both sides of the segments in order to axially interconnect and arrange a plurality of segments via axially passed-through tie rods. Furthermore, feather key grooves are provided in the roller main body or roller shaft to fix the segments radially. A disadvantage here is the manufacturing accuracy required so that the segments correspond radially to the feather keys and the feather key grooves and axially to the shoulder surfaces which as a receptacle for the clamping rings and the tie rods guided thereby.

DE°197°36°087° A1 claims a roller shaft of the dovetail feather keys that are arranged axially thereon. The associated segments have undercut dovetail guide surfaces, which are arranged on the roller shaft in a wedge shape and at an angle to the roller axis and have their maxima between two segments. The at least two segments, each at least one dovetail guide surface wedge, are bolted on and braced against the wedge relative to one another using expansion bolts. A disadvantage here is the manufacturing outlay for the production of the dovetail pairing in the form of a double wedge. In addition, it is difficult or impossible to dismount the segments with the roller installed, because the expansion bolts run through all segments and the segments have to be pulled off axially.

DE°10°2007°032°261° A1 discloses that the segments are connected to the roller shaft via intermediate elements. The intermediate elements in turn have white feather key grooves that run axially and correspond to the roller shaft. The intermediate elements are screwed onto the roller shaft and the segments are screwed onto the intermediate elements. A disadvantage is the use of the intermediate elements with the feather keys and the feather key grooves relative to the roller shaft, which makes the construction complicated and expensive. In addition, there is also the expense of the many bores and screw connections on the circumference of the roller shaft for securing the intermediate elements in place, as well as the positioning of said elements with respect to one another for inserting the screws. It is almost impossible to mount the segments in the installed state because the screws have to reach far into the segments and intermediate elements in the axial direction. The positioning the segment bores over those of the intermediate elements appears to be just as difficult.

The disadvantage of the prior art is that the disclosed segmented rollers have not been successful due to the features described and the disadvantages thereof, and the following:
Inadequate contact and lack of clearance in the case of axial fastening with tie rods: the segments are held in place by clamps on both sides of the roller. In this case, the clamps are braced against each other via tie rods that run through the entire roller. In the installed state, there is no axial clearance for dismounting the tie rods. In the case of wider rollers, another issue is that they do not lie snugly in the middle of the roller, which leads to micro-movements.
Lack of clearance and increased effort required for dismounting in the case of axial fastening with a dovetail guide: in this case, the segments lie snugly, but also require long, axially extending screws for fastening. In this case, too, dismounting is only possible by removing the entire roller.

The problem addressed by the present invention is therefore that of overcoming the disadvantage of the prior art.

The problem is solved by the features of the independent claims. Advantageous embodiments are specified in the dependent claims.

The invention relates to a method for mounting segments on a roller shaft, comprising the following steps:
I: placing a first segment on a roller shaft,
II: positioning the segment by aligning the support surfaces of the segment with the corresponding counterparts of the roller shaft for multiple or double support,
III: arranging at least one mounting means on the segment to secure it in place,
IV: placing at least a second segment on the roller shaft,
V: positioning the second segment by placing the support surfaces on the corresponding counterparts of the roller shaft,
VI: arranging at least one mounting means on the at least one further segment to fix it in place,
VII: inserting at least one bracing element into at least one radially arranged structural configuration, which is suitable for receiving, in the at least two segments on the roller shaft,
VIII: bracing the inserted bracing elements to fix the segments in place relative to each other and with respect to the roller shaft,
IX: removing the at least one mounting means.

The individual steps of the method are listed in a simplified manner. The segments can be placed, for example, by securing the segments to a hoist or by using mounting handles that then enable people to move them. The positioning takes place as a smooth transition from the setting down of the segment on top of the roller core as a further step. For optimal alignment of the segment on the roller core, positioning aids such as fitting bolts/sleeves can be used, or alignment is carried out flush via the mounting collar. A mounting collar should be understood to be a shoulder that is supported on the roller core and preferably runs completely around it. For this purpose, for example, the roller core is fixed and aligned under the relevant segment by rotation. After the positioning is complete and the relevant segment is supported in the correct position on the roller core, mounting means are arranged, for example the segments are fixed relative to the roller core by means of screws. The other segments are then attached according to the previous steps. When all segments are fixed in their position, the respective bracing elements are inserted radially. For example, one or more circumferential grooves can be provided between two or more segments. These bracing elements are preferably bracing sets which brace the segments relative to each other and with respect to the roller shaft. This bracing results in a form-fitting and frictional connection. This combination is considered to be very efficient. In practice, for example, the bracing elements are braced slightly, and the position of the segments is then checked. If the position is correct, there are no further steps to be taken and the mounting means are removed. This is followed by the final bracing of the segments and, if necessary, a final check of the position.

In a further development, the method enables the dismounting of already mounted segments from a roller shaft, comprising the following steps:
I: arranging at least one mounting means on the existing at least two segments to secure them in place,
II: releasing the inserted and prestressed bracing elements,
III: removing the bracing elements and setting them down on the roller shaft or next to the roller,
IV: releasing the at least one mounting means of a first segment,
V: removing the first segment from the roller shaft,
VI: releasing the at least one mounting means of at least a second segment,
VII: removing the second segment from the roller shaft,
VIII: repeating steps VI and VII until all segments to be removed have been completely dismounted.

The process of dismounting segments of the segmented roller begins with arranging mounting means thereon. This secures the segments with respect to the roller core during dismounting. The bracing elements are then released, so that the bracing of the segments is released and the segments can be removed. Owing to the mounting means, the segments remain in their position on the roller core. The bracing occurred between the segments relative to one another and between the individual segments and the roller core. After the mounting means are released, they can be set down on the roller stub, for example, or removed therefrom. This is possible because the bracing elements are arranged radially on the end faces and their space requirement upon removal from the roller is small, which means that the roller does not have to be removed. Eyes for securing or mounting handles can then preferably be attached to the segment that is to be removed. Before removing a segment, the roller should be positioned in such a way that it can be removed from above or from below from the crusher or mill, for example. The roller should then preferably be secured in its position so that the relevant segment can be safely removed after the mounting means have been released and removed. This means that all segments on the roller core, or, if necessary, a single segment, can be removed therefrom.

The invention proposes a segmented roller, in particular for comminuting or compacting bulk material, comprising at least one roller shaft, at least two segments, and at least one radially arranged bracing element, the roller shaft being designed as an n-gon, in particular as a convex and/or regular n-gon, each segment being supported on the roller shaft with multiple support, and the support surfaces forming at least one common corner/transition of the roller shaft and surfaces being supported thereon.

In the broadest sense of the invention, bracing elements are understood to mean elements that have at least one conical surface and/or are designed to enable a frictional shaft-hub connection, and which can also be designed as a bracing set.

The roller shaft designed as an n-gon preferably has an n-gon cross section that runs continuously in the axial direction. The support surfaces formed in this way are distributed n times rotationally symmetrically over the circumference of the shaft. The support surfaces preferably have no structural elements such as a feather key groove, dovetail, or the like.

In embodiments of the invention, a form fit between the roller shaft of the segmented roller and the at least two segments can be achieved by multiple support across corners, this multiple support preferably being a triple support and the support surfaces being circumferentially consecutive.

Within the meaning of the invention, multiple support is understood to mean that at least two segments, preferably a plurality of segments, are arranged on the roller core, where they are supported on a plurality of support surfaces.

In embodiments of the invention of the segmented roller, the multiple support of the segments on the roller shaft is a double support, this double support resulting from at least two adjacent surfaces.

The double support is characterised by adjacent surfaces which are usually positioned at 90 degrees to each other, which results in a superposed form fit in addition to the friction fit via the bracing elements for a stronger shaft-hub connection.

In embodiments of the invention of the segmented roller, the at least one bracing element rests radially in at least one groove on the end faces of the segments. These bracing elements press the segments against the shaft core by means of a friction fit, said segments being prestressed during use.

For this purpose, the grooves can be provided in an end face so as to be circular, it being possible for the number of these grooves to vary; one groove is preferred. Other arrangements of the grooves can also be implemented, such as partial circles between individual segments, these partial circles preferably overlapping one another so that closed prestressing towards the roller core is possible. Grooves arranged on both sides in the segments and arranged symmetrically on the end faces are particularly preferred. Depending on the roller width, it is possible to install single- or multi-row bracing sets on both edges of the roller and to design the segments with appropriate wall thicknesses in order to withstand the high pressing pressures in the middle of the roller.

In embodiments of the invention of the segmented roller, the segments have mounting means on at least one end face, it being possible for these mounting means to surround the shape of the roller shaft, it also being possible for this shape to be interrupted.

Within the meaning of the invention, the mounting means (which may also be referred to herein as mounting fasteners, or individually, as mounting fastener) can be designed, for example, as screws that are carried by a mounting flange or mounting collar, without being limited thereto. The mounting means are preferably provided in one piece and circumferentially on the relevant segment. Different designs, such as interrupted, multi-part mounting means or mounting collars, are conceivable.

The mounting means rest on the roller core or are very slightly spaced therefrom. They are used for easy mounting/dismounting of the segments on the roller core.

In embodiments of the invention, the mounting means are detachably or non-detachably connected to the relevant segment.

These mounting means on the segments, preferably designed as mounting flanges, are detachably connected, preferably screwed, thereto. They can also be non-detachably connected, for example welded or forged on.

In embodiments of the invention, the mounting means of the segmented roller have openings for the detachable arrangement of the segments on the roller shaft.

The segment is thus connected to the shaft via screws during mounting/dismounting and thereby secured.

In embodiments of the invention of the segmented roller, the segments have variable dimensions and material thicknesses, said segments being made of different materials and material combinations.

These materials are preferably metallic, such as cast or forged materials, and particularly preferably steels and alloys thereof. Within the meaning of the invention, composite materials and sintered materials are understood to mean a combination of materials, without being limited thereto.

In embodiments of the invention of the segmented roller, it is formed integrally by the roller shaft and roller core. This roller shaft thus has connections and roller cores which are integral components of the roller shaft. In a further embodiment of the invention, the components are designed to be partially integral and, for example, the roller core is shrunk onto the shaft with the connections.

A further aspect of the invention relates to the use of a method according to the invention for mounting and/or dismounting a segmented roller according to the invention.

Another aspect of the invention is the use of a segmented roller according to the invention using a method according to the invention.

In one of the claimed embodiments, the claimed method and/or the segmented roller prevent the erosion of screw bores in the case of radial fastening, because these can advantageously be dispensed with: if the segments are screwed radially to the main body, they can be dismounted without removing the rollers. However, due to the high pressing pressures, the counterbores are eroded. If the segments are only screwed to the roller edge, this in turn leads to insufficient support for the segments.

The disadvantages of the prior art are overcome by the claimed method and/or the segmented roller.

### EMBODIMENT

The invention will be explained in greater detail below with reference to an embodiment. The embodiment is intended to describe the invention without limiting it.

In the drawings:

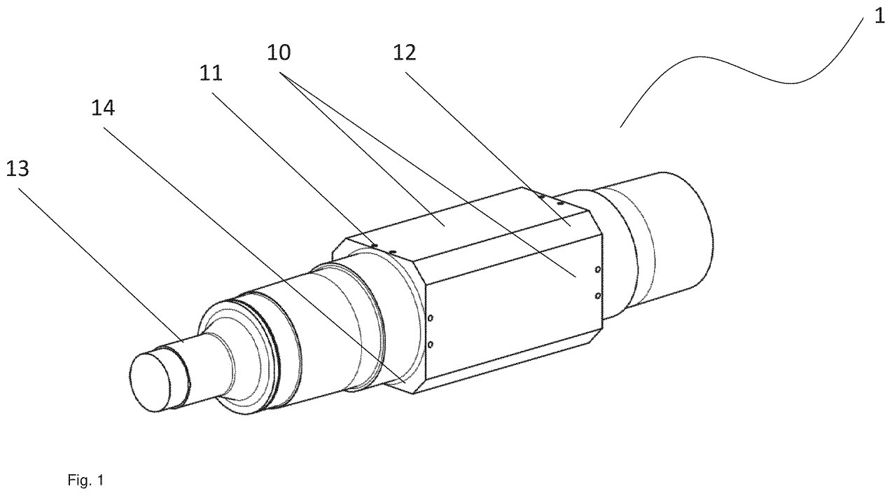

FIG. 1 is a schematic representation of an embodiment of a roller shaft according to the invention,

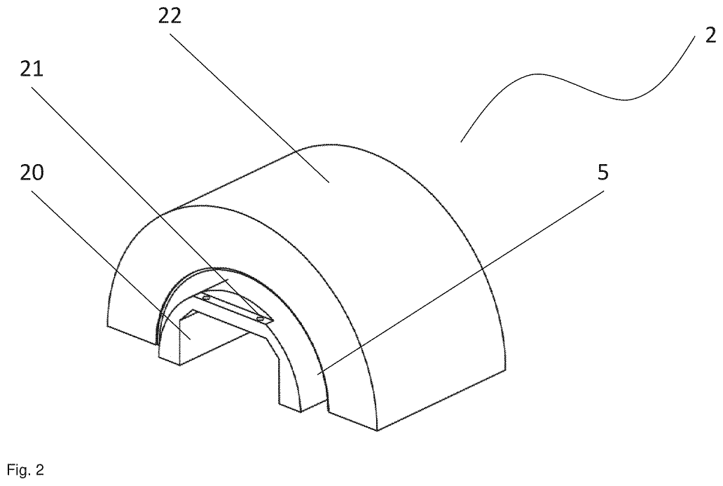

FIG. 2 is a schematic representation of an embodiment of a segment according to the invention in a half-shell outside view,

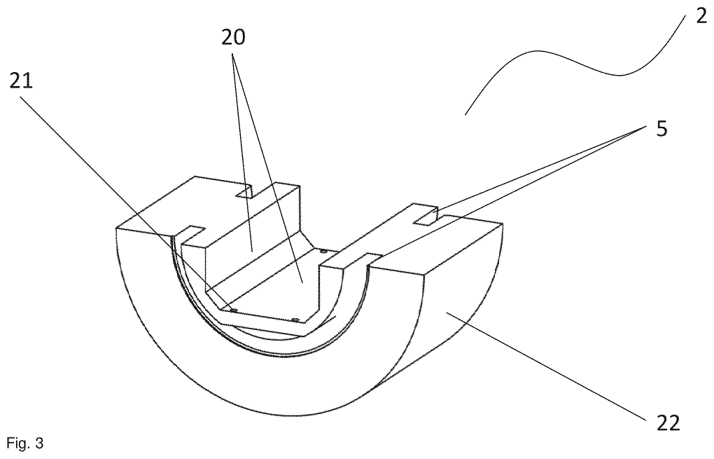

FIG. 3 is a schematic representation of an embodiment of a segment according to the invention in a half-shell inside view,

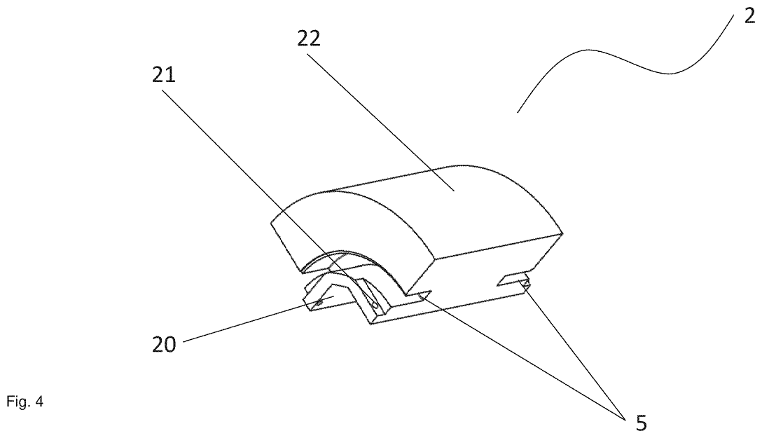

FIG. 4 is a schematic representation of an embodiment of a segment according to the invention in a quarter-shell outside view,

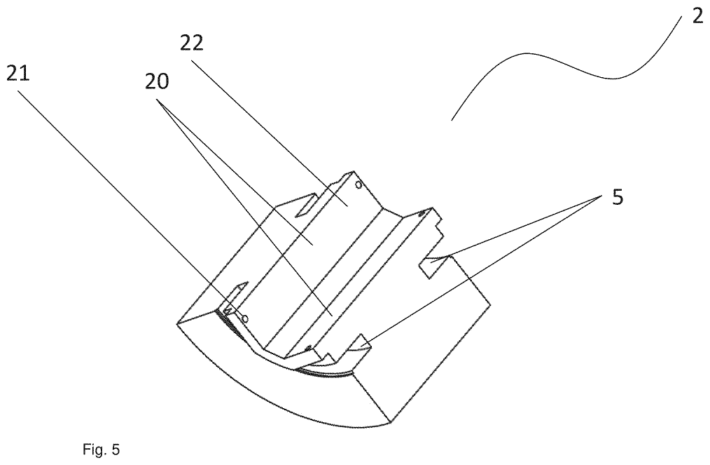

FIG. 5 is a schematic representation of an embodiment of a segment according to the invention in a quarter-shell inside view,

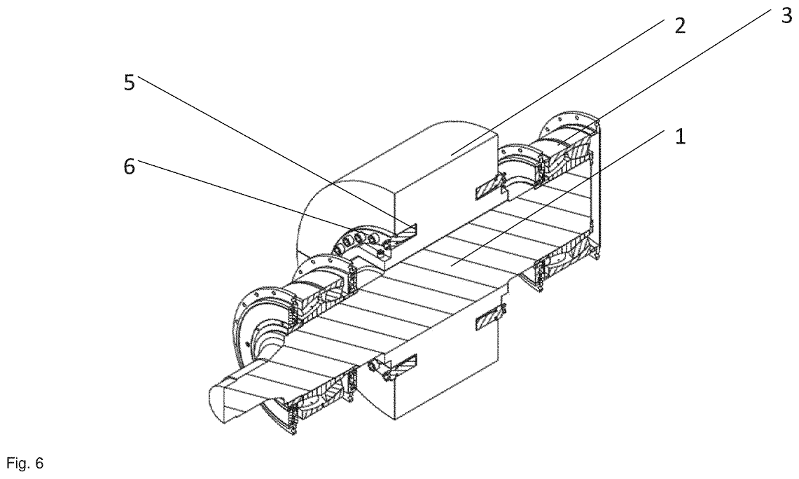

FIG. 6 is a schematic representation of an embodiment of a segmented roller according to the invention in a sectional view,

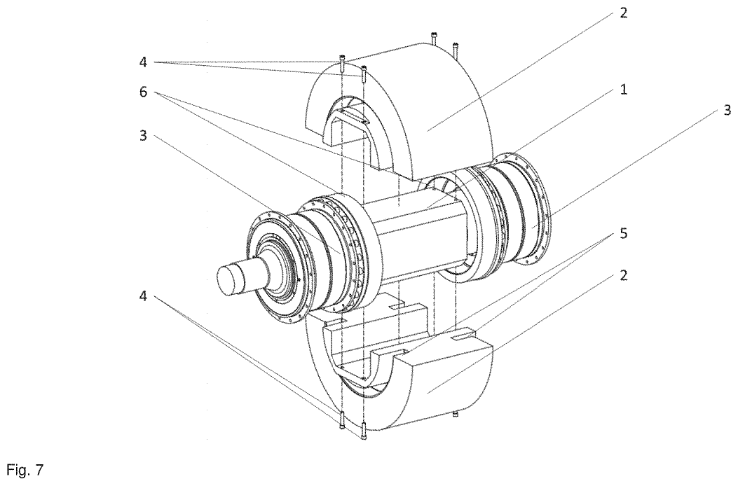

FIG. 7 is a schematic representation of an embodiment of a segmented roller according to the invention in a half-shell exploded view,

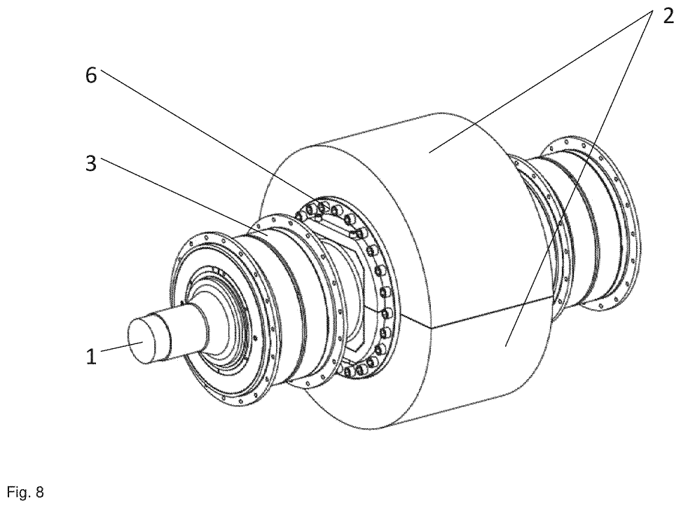

FIG. 8 is a schematic representation of an embodiment of a segmented roller according to the invention in a half-shell isometric view,

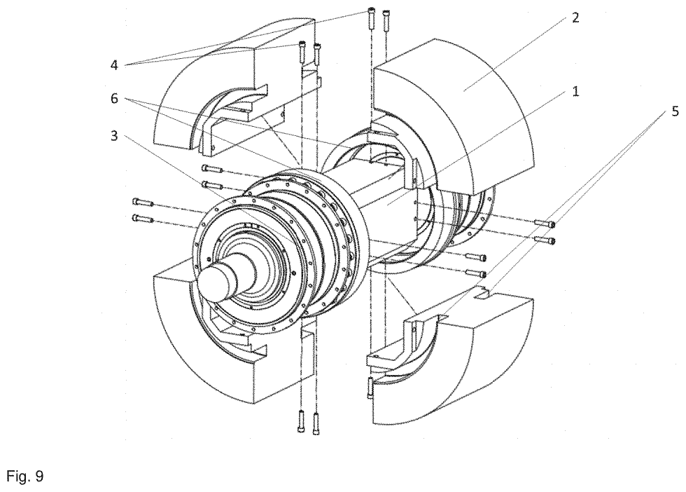

FIG. 9 is a schematic representation of an embodiment of a segmented roller according to the invention in a quarter-shell exploded view,

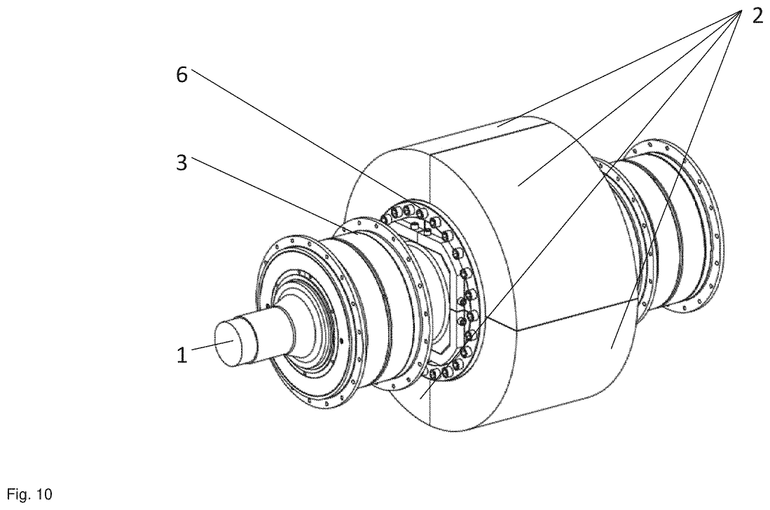

FIG. 10 is a schematic representation of an embodiment of a segmented roller according to the invention in a quarter-shell exploded view.

FIG. 1 is a schematic representation of an embodiment of a roller shaft 1 according to the invention in which the roller shaft and roller core are integral. The support surfaces of the roller shaft 10 can be seen here, on the outer regions of which the receptacles for the mounting means 11 are provided. Chamfers 12 are arranged between the support surfaces. Furthermore, it can be seen that the roller shaft has connections 13 and roller core 14, which are integral components of the roller shaft. The design of the roller shaft 1 shown here is suitable for receiving or forming the shell over two, as well as over four, segments.

FIG. 2 is a schematic representation of a segment 2 according to the invention, in this case in the embodiment as a half-shell in the outside view. The support surfaces 20 of the segment, the passages for mounting means 21, a groove, here provided circumferentially, and the segment working surface 22 can be seen here. The segment 2 has two mounting means passages 21 on each end face, by means of which said segment is secured on the roller shaft during mounting/dismounting. The provided groove 5 serves to accommodate the bracing element(s). The design as a half-shell, i.e. two segments on the roller shaft, is the minimum for radial dismounting; however, there can also be significantly more (e.g. four segments, see FIG. 4, for example). There are no restrictions with regard to the shape, number, and material of the segments. The number of segments only needs to be matched to the support surfaces 20 of the segments and the support surfaces of the roller shaft. According to the invention, it is possible to profile the roller surface or the segment working surface 22 for improved infeed or to suitably hollow them for briquetting presses. The segment can be designed as a one-piece solid segment (e.g. white cast iron) or as a multi-piece composite segment (with sintered wear plates, grid armour, or build-up welding on the segment surface). The gap between adjacent segments must be dimensioned in such a way that material can settle there, thus achieving autogenous protection against wear, and cannot flow away laterally, so that erosion in the gap region is prevented.

FIG. 3 is a schematic representation of an embodiment of a segment 2 according to the invention, in this case as a half-shell in the inside view. The support surfaces 20 of the segment can be clearly seen; in the case of half-shells, these are one full support surface and two half support surfaces. Furthermore, a groove 5 can be seen on each end face. These are used to receive bracing elements. The passages 21 for the mounting means can also be seen. Two of these are arranged on each end face.

FIG. 4 is a schematic representation of an embodiment of a segment 2 according to the invention, which can be seen here as a quarter-shell in the outside view. In the case of quarter-shells, four segments are required on the circumference of the roller. For this purpose, a groove 5 is provided on each end face in this segment. In addition, a passage 21 for mounting means is provided in each case on in the edges of the support surfaces 20. The freely configurable working surface 22 of the segment is also shown here.

FIG. 5 is a schematic representation of an embodiment of a segment 2 according to the invention, which can be seen here as a quarter-shell in the inside view. The two grooves 5 are also shown here, as are the four passages 21 for mounting means. One of these is provided in each support surface 20 and end face.

FIG. 6 is a schematic representation of an embodiment of a segmented roller according to the invention; this is shown here in a sectional view and in a perspective view. The figure shows the roller shaft 1, which is shown with hatching. A bearing 3 is arranged on the outer ends of this roller shaft 1, by means of which bearing the segmented roller is supported and guided in a housing. A segment 2, designed here as a half-shell, adjoins the centre of the roller shaft 1. This segment 2 has a radially circumferential groove 5 on each end face. A bracing element 6 is inserted and prestressed in this groove 5. The bracing element 6 is shown with hatching because it is designed to be fully circumferential and has therefore been sectioned in the view.

FIG. 7 is a schematic representation of an embodiment of a segmented roller according to the invention. The segments 2 shown are half-shells in an exploded view of a segmented roller. The roller shaft 1, on which two segments 2 with corresponding mounting means 4 are provided, is shown from the inside to the outside. The bracing elements 6 can be seen axially outward next to the segments 2. When installed, these bracing elements are arranged in the grooves 5 and brace the segments 2 against one another and against the roller shaft 1. The bearings 3 axially adjoin the bracing elements 6.

FIG. 8 is a schematic representation of an embodiment of a segmented roller according to the invention, with half-shells in an isometric view. This is intended to clarify how the segments 2 with the bracing elements 6 are arranged on the roller shaft 1 with the respective bearings 3 assembled together. The bracing elements 6 generate a force when they are prestressed which braces the segments 2 against the roller shaft 1.

FIG. 9 is a schematic representation of an embodiment of a segmented roller according to the invention, with quarter-shells in an exploded view. The four segments 2 all have a groove 5 on each end face which serves to receive the bracing elements 6. The support surfaces on the roller shaft 1 comprise the passage or receptacle for the mounting means 4 on the end faces thereof. The bracing elements 6, by means of which said segments are braced against each other and the roller shaft 1, are arranged in the grooves 4. The bearings 3, which guide the segmented roller in a housing (not shown here), can also be seen.

FIG. 10 is a schematic representation of an embodiment of a segmented roller according to the invention, here with quarter-shells in an isometric view. The four segments 2 on the roller shaft 1, which are braced on said roller shaft by means of the bracing elements 6, can be seen. The bearings 3, which are used for bearing in a housing, can also be seen. The embodiment shown here likewise shows the mounting means and the bracing elements 6 in the installed state. This is only the case during mounting or dismounting. During use, the mounting means are preferably removed again, thus dispensing with the position-securing of said mounting means.

### LIST OF REFERENCE SIGNS

1 Roller shaft, roller core
2 Segment
3 Bearing
4 Mounting means
5 Groove
6 Bracing element
10 Roller shaft support surface
11 Mounting means receptacle
12 Support surface chamfer
13 Roller shaft connection, integral
14 Roller-shaft roller core, integral
20 Segment support surface
21 Mounting means passage
22 Segment working surface

1. A method for mounting segments on a roller shaft, comprising the following steps:
I: placing a first segment on the roller shaft,
II: positioning a segment by aligning support surfaces of the segment with corresponding counterparts of the roller shaft for multiple or double support,
III: arranging at least one mounting fastener on the segment to secure it in place,
IV: placing at least a second segment on the roller shaft,
V: positioning the at least one segment by placing the support surfaces on the corresponding counterparts of the roller shaft,
VI: arranging at least one mounting fastener on the at least a second segment to fix it in place,
VII: inserting at least one bracing element into at least one radially arranged structural configuration, which is suitable for receiving, in the at least two segments on the roller shaft,
VIII: bracing the inserted bracing elements to fix the segments in place relative to each other and with respect to the roller shaft, and
IX: removing the at least one mounting fastener.

2. A method for dismounting segments, which have been mounted according to claim 1, from a roller shaft, comprising the following steps:
I: arranging at least one mounting fastener on the existing at least two segments to secure them in place,
II: releasing the inserted and prestressed bracing elements,
III: removing the bracing elements,
IV: releasing the at least one mounting fastener of a first segment,
V: removing a first segment from the roller shaft,
VI: releasing the at least one mounting fastener of at least a second segment,
VII: removing the at least second segment from the roller shaft, and
VIII: repeating steps VI and VII until all segments to be removed have been completely dismounted.

3. The method for dismounting segments according to claim 2, wherein, after the removal of the bracing elements, said bracing elements are set down on the roller shaft or next to the roller.

4. A segmented roller, comprising at least one roller shaft, at least two segments, and at least one radially arranged bracing element, wherein the roller shaft is designed as an n-gon, wherein each segment is supported on the roller shaft with multiple support, and wherein support surfaces form at least one common corner/transition of the roller shaft and surfaces are supported thereon.

5. The segmented roller according to claim 4, wherein the roller shaft achieves a form fit by means of multiple support of the segments across corners.

6. The segmented roller according to claim 4, wherein the multiple support of the segments on the roller shaft is a double support, this double support resulting from at least two adjacent surfaces.

7. The segmented roller according to claim 4, wherein the at least one bracing element rests radially in at least one groove on end faces of the segments and presses said segments against the shaft by means of a friction fit, said segments being prestressed during use.

8. The segmented roller according to claim 4, wherein the segments have mounting fasteners on at least one end face, said mounting fasteners surrounding the shape of the roller shaft.

9. The segmented roller according to claim 4, wherein the mounting fasteners are detachably or non-detachably connected to the respective segments.

10. The segmented roller according to claim 4, wherein the mounting fasteners have openings for the detachable arrangement of the segments on the roller shaft.

11. The segmented roller according to claim 4, wherein the segments have variable dimensions and material thicknesses, said segments being made of different materials and material combinations.

12. The segmented roller according to claim 7, wherein the roller shaft achieves a form fit by means of multiple support of the segments across corners.

13. The segmented roller according to claim 7, wherein the multiple support of the segments on the roller shaft is a double support, this double support resulting from at least two adjacent surfaces.

14. The segmented roller according to claim 12, wherein the segments have mounting fasteners on at least one end face, said mounting fasteners surrounding the shape of the roller shaft.

15. The segmented roller according to claim 13, wherein the segments have mounting fasteners on at least one end face, said mounting fasteners surrounding the shape of the roller shaft.

16. The segmented roller according to claim 14, wherein the mounting fasteners are detachably or non-detachably connected to the respective segments.

17. The segmented roller according to claim 15, wherein the mounting fasteners are detachably or non-detachably connected to the respective segments.

18. The segmented roller according to claim 16, wherein the mounting fasteners have openings for the detachable arrangement of the segments on the roller shaft.

19. The segmented roller according to claim 17, wherein the mounting fasteners have openings for the detachable arrangement of the segments on the roller shaft.

20. A method for comminuting or compacting bulk material, said method comprising contacting the bulk material with the segmented roller according to claim 4.
